(19) United States
(12) Patent Application Publication
(10) Pub. No.: US 2026/0128457 A1
(43) Pub. Date: May 7, 2026

(54) TRACTION BATTERY PACK VENTING SYSTEM WITH COATED AREA SHIELD

(71) Applicant: Ford Global Technologies, LLC, Dearborn, MI (US)

(72) Inventor: Xiaogang Zhang, Novi, MI (US)

(21) Appl. No.: 18/936,051

(22) Filed: Nov. 4, 2024

(51) Int. Cl. H01M 50/358; B60L 50/64; B60L 58/26; H01M 10/613; H01M 10/625; H01M 10/6567; H01M 50/213

(52) U.S. Cl. CPC H01M 50/358; B60L 50/64; B60L 58/26; H01M 10/613; H01M 10/625; H01M 10/6567; H01M 50/213; H01M 2220/20

(57) ABSTRACT

A traction battery pack venting system includes one or more battery cells and a venting chamber adjacent the one or more battery cells. The one or more battery cells are configured to vent to the venting chamber. The venting chamber has an inner wall and an outer wall. The outer wall can include outer wall vent openings. Each of the outer wall vent openings is configured to receive vent byproducts discharged from one of the one or more battery cells. The inner wall can include inner wall inlets each configured to receive vent byproducts discharged from one of the one or more battery cells.

### TECHNICAL FIELD

This disclosure relates generally to a venting system for a battery pack and, more particularly, to a venting system for a battery pack that can shield coated areas of the battery pack from vent byproducts.

### BACKGROUND

Electrified vehicles differ from conventional motor vehicles because electrified vehicles can be selectively driven by one or more electric machines that are powered by a traction battery pack. The electric machines can propel the electrified vehicles instead of, or in combination with, an internal combustion engine. The traction battery pack is discharged when powering the one or more electric machines and other loads of the electrified vehicle.

### SUMMARY

In some aspects, the techniques described herein relate to a traction battery pack venting system, including: one or more battery cells; and a venting chamber adjacent the one or more battery cells, the one or more battery cells configured to vent to the venting chamber, the venting chamber having an inner wall and an outer wall.

In some aspects, the techniques described herein relate to a venting system, wherein the outer wall includes a plurality of outer wall vent openings, each of the outer wall vent openings is configured to receive vent byproducts discharged from one of the one or more battery cells, wherein the inner wall includes a plurality of inner wall inlets each configured to receive vent byproducts discharged from one of the one or more battery cells.

In some aspects, the techniques described herein relate to a venting system, wherein the one or more battery cells are immersion cooled.

In some aspects, the techniques described herein relate to a venting system, wherein the one or more battery cells are cylindrical battery cells.

In some aspects, the techniques described herein relate to a venting system, wherein the outer wall is at least partially electrocoated.

In some aspects, the techniques described herein relate to a venting system, wherein at least the outer wall is a coated metal or a coated metal alloy.

In some aspects, the techniques described herein relate to a venting system, wherein the venting chamber is sealed from a cell chamber that encloses the one or more battery cells such that liquid communicated through the cell chamber as part of an immersion thermal management system is blocked from entering the venting chamber.

In some aspects, the techniques described herein relate to a venting system, wherein the inner wall is a folded sheet of material.

In some aspects, the techniques described herein relate to a venting system, wherein the inner wall is angled relative to the outer wall to provide gaps between the inner wall and the outer wall.

In some aspects, the techniques described herein relate to a venting system, wherein the inner wall has an inner wall floor that is adjacent an outer wall floor of the outer wall, the inner wall floor tilted relative to the outer wall floor to provide an air gap between the inner wall floor and the outer wall floor.

In some aspects, the techniques described herein relate to a venting system, wherein the air gap has a triangular profile.

In some aspects, the techniques described herein relate to a venting system, wherein the inner wall has a wave-shaped profile.

In some aspects, the techniques described herein relate to a venting system, wherein the inner wall is disposed within the venting chamber opposite an outer wall vent opening that receives vent byproducts from one or more of the one or more battery cells, the outer wall vent opening in the outer wall.

In some aspects, the techniques described herein relate to a venting system, wherein vent byproducts are contained with the venting chamber by the inner wall on a bottom side, by the outer wall on opposing horizontally facing sides, and by the outer wall on a top side.

In some aspects, the techniques described herein relate to a venting system, wherein the inner wall overlaps exclusively a floor of the outer wall.

In some aspects, the techniques described herein relate to a traction battery pack venting system, including: an enclosure assembly having an enclosure interior; a divider within the enclosure interior, the divider separating a cell chamber of the enclosure interior from one or more venting chambers of the enclosure interior; a thermal management system having a liquid, the thermal management system configured to circulate the liquid through the cell chamber; and one or more battery cells disposed within the cell chamber, the one or more battery cells configured to vent into the one or more venting chambers, the one or more venting chambers each having an inner wall and an outer wall.

In some aspects, the techniques described herein relate to a venting system, wherein the outer wall includes a plurality of outer wall vent openings each configured to receive vent byproducts discharged from one of the one or more battery cells, wherein the inner wall includes a plurality of inner wall inlets each configured to receive vent byproducts discharged from one of the one or more battery cells.

In some aspects, the techniques described herein relate to a venting system, wherein the thermal management system circulates the liquid through the cell chamber without the liquid passing through the one or more venting chambers.

In some aspects, the techniques described herein relate to a venting system, wherein the inner wall is angled relative to the outer wall to provide gaps between the inner wall and the outer wall.

In some aspects, the techniques described herein relate to a venting system, wherein at least the outer wall is a coated metal or a coated metal alloy.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of a battery cell from the battery pack of FIG. 1.

FIG. 3 illustrates another perspective view of the battery cell of FIG. 2.

FIG. 4 illustrates a perspective view of the battery pack from the electrified vehicle of FIG. 1 according to an exemplary embodiment of the present disclosure.

FIG. 5 illustrates an expanded view of the battery pack of FIG. 4.

FIG. 6 illustrates a section view taken at line 6-6 in FIG. 4.

FIG. 7 illustrates a section view taken at line 7-7 in FIG. 4.

FIG. 8 illustrates a close-up view of an area of FIG. 7 and showing an end view of an inner wall according to the exemplary embodiment.

FIG. 8A illustrates the same area of FIG. 8 showing an inner wall according to another exemplary embodiment.

FIG. 9 illustrates a sheet of material that can be folded to provide an inner wall for the battery pack of FIG. 4.

FIG. 10 illustrates a section view of a battery pack having an inner wall according to another exemplary embodiment during assembly.

FIG. 11 illustrates the section view of FIG. 10 after assembly.

### DETAILED DESCRIPTION

This disclosure details exemplary traction battery packs with venting systems. The venting systems can include a venting chamber. During a thermal event, battery cells can vent into the venting chamber having an inner wall and an outer wall. The inner wall can prevent vent byproducts discharged from one or more battery cells from impinging directly on the outer wall, which can be coated.

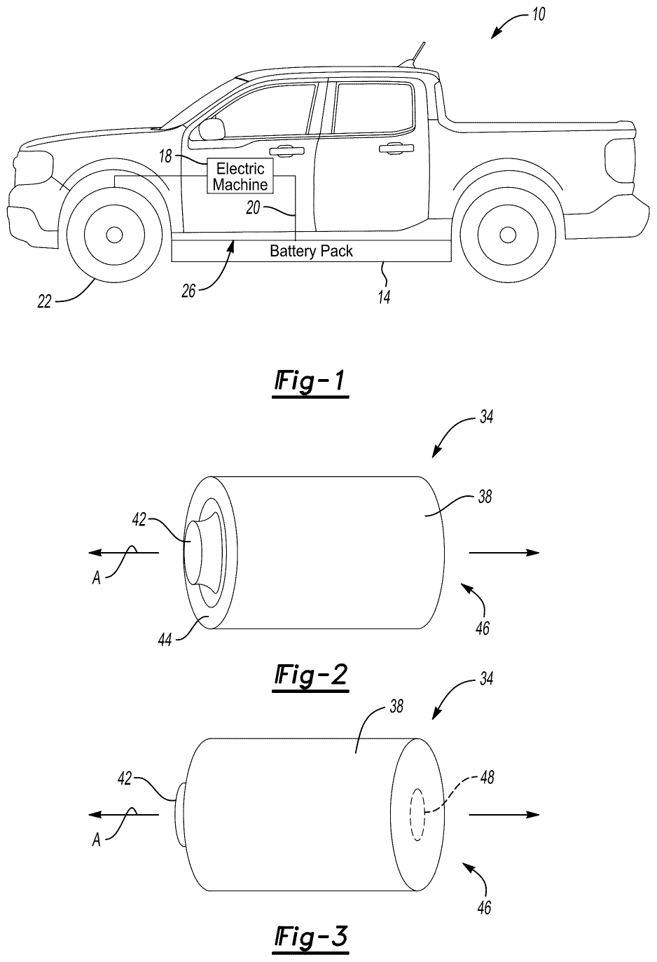

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

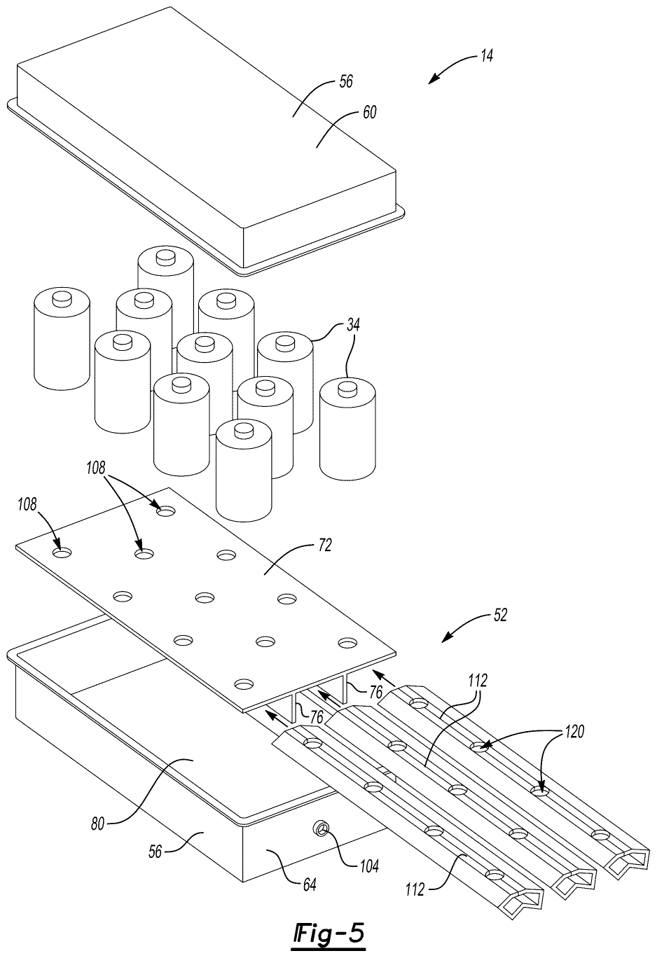

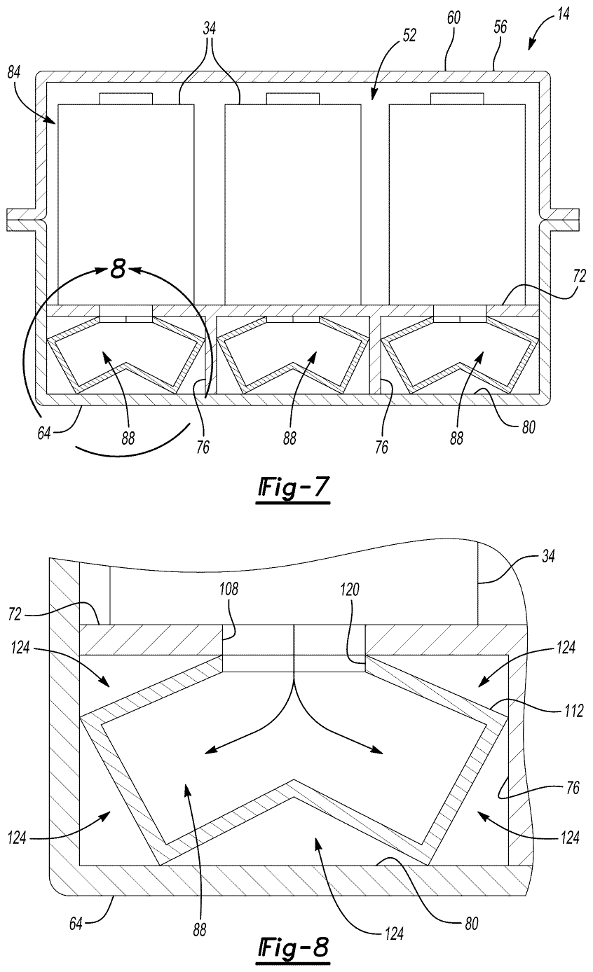

With reference now to FIG. 2-7, the battery pack 14 of the exemplary embodiment includes a plurality of battery cells 34. The battery cells 34 are cylindrical battery cells in this example. In particular, the example battery cells 34 each have a jellyroll-style electrode structure housed within an case 38. The cylindrical battery cells 34 are each disposed along a respective battery cell axis A.

A cap 42 of the case 38 provides a positive terminal at a first axial end of each cell 34. The cap 42 is raised above an ring 44, which provides a negative terminal at the first axial end of each cell 34. A venting side 46 of the case 38 is located at an opposite, second axial end of each cell 34. A venting passage 48 extends through the venting side 46. Should a thermal event lead to one of the cells 34 venting, the venting passage 48 can provide a path for expelling vent byproducts from that one of the cells 34. The venting passage 48 can be covered—by a membrane, for example—until the cell 34 begins to vent. The increased pressure within one of the cells 34 can rupture the membrane to allow vent byproducts to pass through the venting passage 48.

Busbars can connect to the terminals provided by the caps 42 and rings 44 of the cells 34 to electrically couple the cells 34 to other cells 34, to other components of the battery pack 14, or both. The busbars are omitted from the figures.

The example battery pack 14 houses the batteries 34 an interior 52 of an enclosure assembly 56. In the exemplary embodiment, the enclosure assembly 56 includes an enclosure cover 60 and an enclosure tray 64. The enclosure cover 60 can be secured to the enclosure tray 64 to provide the interior 52 that houses the batteries 34. The enclosure cover 60 can be secured to the enclosure tray 64 using mechanical fasteners (not shown), for example.

Within the interior 52, the batteries 34 are supported on a platform 72. Legs 76 extend downward from the platform 72 to a floor 80 of the enclosure tray 64 to elevate the platform 72 above the floor 80 within the interior 52. The platform 72 divides the interior 52 into a cell chamber 84 and a venting chamber 88.

The example battery pack 14 manages thermal energy of the battery cells 34 and other components of the battery pack 14 using a liquid. The cells 34 and other components of the battery pack 14 are at least partially immersed in the liquid. Thermal energy within the battery pack 14 is thus managed using an immersion thermal management system.

In this example, the liquid cools the battery cells 34 and the other components of the battery pack 14. In another example, the liquid could instead or additionally be used to heat the battery cells 34 and the other components. The liquid can be a dielectric coolant, for example.

In this example, a pump 92 circulates the liquid through the cell chamber 84. The platform 72 blocks the liquid from entering the venting chamber 88. The battery cells 34 are enclosed within the cell chamber 84.

Within the cell chamber 84, the liquid moves over the battery cells 34 and other components and takes on thermal energy from the battery cells 34 and the other components. The liquid then moves from the battery pack 14 to a thermal exchange device 96. Thermal energy can be transferred away from the liquid at the thermal exchange device 96.

From the thermal exchange device 96, the liquid moves to a liquid supply 100. The liquid is drawn from the liquid supply 100, as required, and circulated by the pump 92 back to the battery pack 14.

In this example, the battery pack 14 includes three venting chambers 88—one under each row of battery cells 34. The legs 76 separate the venting chambers 88 from each other within the interior 52. Generally, the enclosure tray 64, the legs 76, and the platform 72 establish a perimeter of the venting chambers 88. In this example, the enclosure tray 64, the legs 76, and the platform 72 provide an outer wall for each of the venting chambers 88.

The venting chambers 88 are sealed from the cell chamber 84 of the interior 52 by the platform 72 such that liquid communicated through the cell chamber as part of an immersion thermal management system is blocked from entering the venting chambers 88.

The battery pack 14 includes a vent 104 within the enclosure tray 64. The legs 76 are spaced from a side of the enclosure tray 64 having the vent 104 to provide a gap G to the side (FIG. 6). Vent byproducts within any of the venting chamber 88 can exit the enclosure assembly 56 through the vent 104. Vent byproducts received within the venting chambers 88 can flow to the gap G through the vent 104.

The platform 72 includes a plurality of outer wall vent openings 108. Each outer wall vent opening 108 is aligned with the venting passage 48 for each of the battery cells 34. When one of the battery cells 34 experiences a thermal event, vent byproducts can be discharged through the venting passage 48, through the outer wall vent opening 108, and into one of the venting chambers 88.

The enclosure assembly 56 can be a metal or metal alloy, such as steel. The enclosure assembly 56 can be coated with a coating, such as a coating that resist rusting of the enclosure assembly 56. Both outer and inner surfaces of the enclosure assembly 56 can be coated with the coating, which is an electrocoating in some examples. In some examples, the platform 72 and the legs 76 can also be coated.

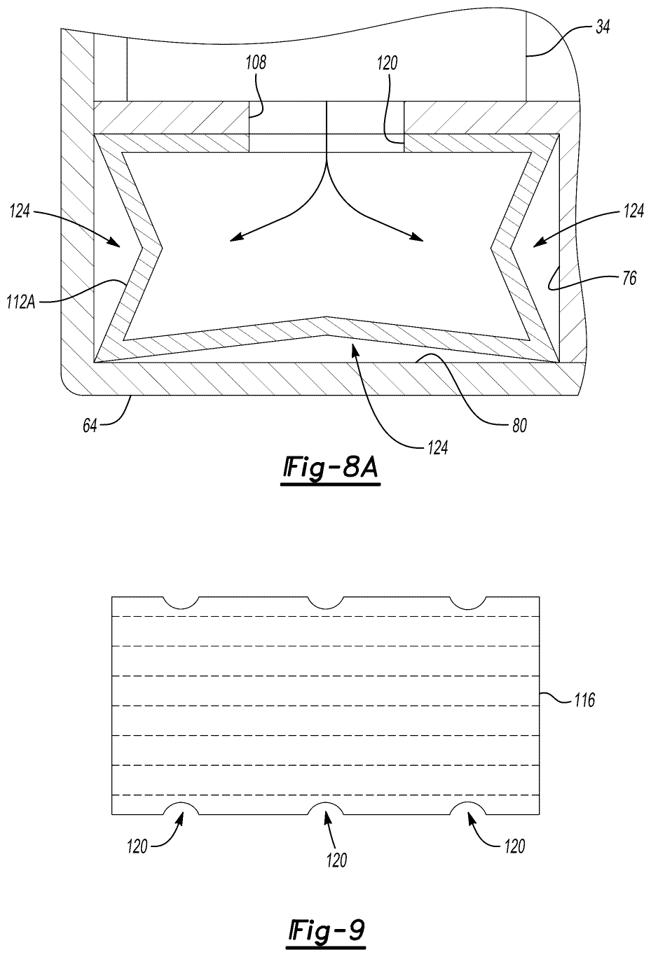

To shield coated areas from the vent byproducts, the example battery pack 14 includes an inner wall 112 within each of the venting chambers 88. Each of the inner wall 112 is provided by a sheet of material 116 as shown in FIG. 9. To provide the example inner wall 112, notches 120 are cut into the sheet of material 116. Next, the sheet of material 116 is bent about the broken lines shown in FIG. 9 until the inner wall 112 has the shape shown in FIG. 8. The inner walls 112 are thus provided by a folded sheet of material. FIG. 8 shows an inner wall 112A according to another exemplary aspect of the present disclosure where the sheet of material 116 is bent a bit differently.

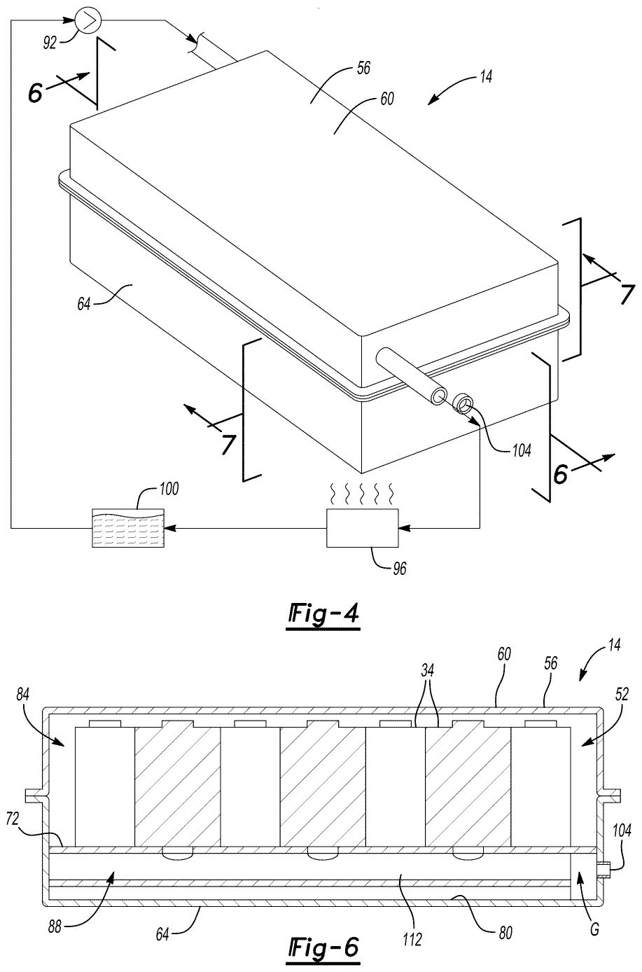

Referring again to FIG. 4-8, vent byproducts that have moved through the outer wall vent opening 108 move through the notches 120 in the inner wall 112 as shown by the arrows in FIG. 8. The notches 120 establish inner wall vent openings. The inner wall 112 shields the enclosure tray 64 from the vent byproducts by blocking the vent byproducts from impinging directly on the enclosure tray 64. Accordingly, the vent byproducts do not heat up a coated area of the enclosure tray 64 as much as the vent byproducts would if the vent byproducts impinged directly on the enclosure tray 64. If the platform 72 or the legs 76 are also coated, the inner wall 112 shields these areas as well.

Due to the angles at which the inner wall 112 is tilted or bent relative to the outer wall, most of the inner wall 112 is angled and spaced from the enclosure tray 64, the legs 76, and the platform 72 to establish air gaps 124 within the venting chamber 88. The air gaps 124 are within the venting chambers 88 but outside the inner wall 112. The air gaps 124 can further insulate and reduce thermal energy transfer to the enclosure tray 64, the legs 76, and the platform 72. The air gaps 124 each have a triangular profile in this example.

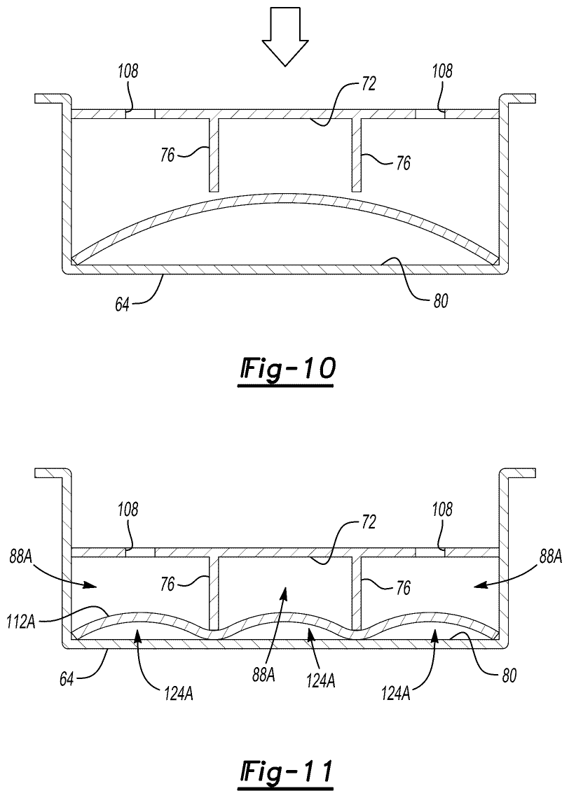

With reference to FIGS. 10 and 11, in another exemplary embodiment, an inner wall 112A is positioned within the venting chambers 88A along the floor 80 of the enclosure tray 64 but not adjacent the legs 76 or the platform 72. The inner wall 112A is opposite the outer wall vent openings 108.

In an example, the inner wall 112A can be a sheet of mica material. During assembly, as shown in FIG. 10, the inner wall 112A can be fit within the enclosure tray 64 prior to positioning the platform 72 and the legs 76. The inner wall 112A can have an arc-shaped profile.

Next, the platform 72 and the legs 76 are positioned within the enclosure tray 64. The inner wall 112A is sandwiched between the floor 80 and the legs 76. The inner wall 112A has a smaller arced profile in each venting chamber 88A to provide an air gap 124A between the floor 80 and the inner wall 112A in each venting chamber 88A. This gives the inner wall 112A a wave-shaped profile. The inner wall 112A and the air gap 124A can reduce thermal energy transfer to the floor 80 and any coating on the floor 80.

In this example, the inner wall 112A overlaps exclusively the floors 80 of the venting chambers 88A. Vent byproducts are contained with the venting chambers 88A by the inner wall 112A on a bottom side of the venting chambers 88A, by the legs 76 (i.e., the outer wall) on opposing horizontally facing sides, and by the platform (i.e., the outer wall) on a top side. Bottom and top are, for purposes of this disclosure, with reference to ground and a general orientation of the battery pack 14 when installed within the vehicle 10.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack venting system, comprising:
one or more battery cells; and
a venting chamber adjacent the one or more battery cells, the one or more battery cells configured to vent to the venting chamber, the venting chamber having an inner wall and an outer wall.

2. The venting system of claim 1, wherein the outer wall includes a plurality of outer wall vent openings, each of the outer wall vent openings is configured to receive vent byproducts discharged from one of the one or more battery cells, wherein the inner wall includes a plurality of inner wall inlets each configured to receive vent byproducts discharged from one of the one or more battery cells.

3. The venting system of claim 1, wherein the one or more battery cells are immersion cooled.

4. The venting system of claim 1, wherein the one or more battery cells are cylindrical battery cells.

5. The venting system of claim 1, wherein the outer wall is at least partially electrocoated.

6. The venting system of claim 1, wherein at least the outer wall is a coated metal or a coated metal alloy.

7. The venting system of claim 1, wherein the venting chamber is sealed from a cell chamber that encloses the one or more battery cells such that liquid communicated through the cell chamber as part of an immersion thermal management system is blocked from entering the venting chamber.

8. The venting system of claim 1, wherein the inner wall is a folded sheet of material.

9. The venting system of claim 1, wherein the inner wall is angled relative to the outer wall to provide gaps between the inner wall and the outer wall.

10. The venting system of claim 1, wherein the inner wall has an inner wall floor that is adjacent an outer wall floor of the outer wall, the inner wall floor tilted relative to the outer wall floor to provide an air gap between the inner wall floor and the outer wall floor.

11. The venting system of claim 10, wherein the air gap has a triangular profile.

12. The venting system of claim 1, wherein the inner wall has a wave-shaped profile.

13. The venting system of claim 1, wherein the inner wall is disposed within the venting chamber opposite an outer wall vent opening that receives vent byproducts from one or more of the one or more battery cells, the outer wall vent opening in the outer wall.

14. The venting system of claim 1, wherein vent byproducts are contained with the venting chamber by the inner wall on a bottom side, by the outer wall on opposing horizontally facing sides, and by the outer wall on a top side.

15. The venting system of claim 1, wherein the inner wall overlaps exclusively a floor of the outer wall.

16. A traction battery pack venting system, comprising:
an enclosure assembly having an enclosure interior;
a divider within the enclosure interior, the divider separating a cell chamber of the enclosure interior from one or more venting chambers of the enclosure interior;
a thermal management system having a liquid, the thermal management system configured to circulate the liquid through the cell chamber; and
one or more battery cells disposed within the cell chamber, the one or more battery cells configured to vent into the one or more venting chambers, the one or more venting chambers each having an inner wall and an outer wall.

17. The venting system of claim 16, wherein the outer wall includes a plurality of outer wall vent openings each configured to receive vent byproducts discharged from one of the one or more battery cells, wherein the inner wall includes a plurality of inner wall inlets each configured to receive vent byproducts discharged from one of the one or more battery cells.

18. The venting system of claim 16, wherein the thermal management system circulates the liquid through the cell chamber without the liquid passing through the one or more venting chambers.

19. The venting system of claim 16, wherein the inner wall is angled relative to the outer wall to provide gaps between the inner wall and the outer wall.

20. The venting system of claim 16, wherein at least the outer wall is a coated metal or a coated metal alloy.
